(19) United States
(12) Patent Application Publication
(10) Pub. No.: US 2026/0050175 A1
(43) Pub. Date: Feb. 19, 2026

(54) REFLECTIVE POLARIZING OPTICAL ELEMENT, OPTICAL DEVICE, DISPLAY APPARATUS, AND METHOD FOR MANUFACTURING REFLECTIVE POLARIZING OPTICAL ELEMENT

(71) Applicant: CANON KABUSHIKI KAISHA, Tokyo (JP)

(72) Inventors: Kaneto TSUNEMITSU, Kanagawa (JP); Kouichi YONETANI, Kanagawa (JP); Kumiko YASHIMA, Tokyo (JP)

(21) Appl. No.: 19/291,965

(22) Filed: Aug. 6, 2025

(30) Foreign Application Priority Data
Aug. 13, 2024 (JP) 2024-134895

(51) Int. Cl. G02B 27/28; G02B 27/01

(52) U.S. Cl. CPC G02B 27/283; G02B 27/0172

(57) ABSTRACT

Provided is a reflective polarizing optical element includes: a substrate including a curved surface portion forming a curved surface, and having, in a plan view of an optical axis direction, when the curved surface portion has a shape surrounded by a plurality of arcs each forming a part of the same circle in the plan view, and by a line connecting ends of adjacent arcs among the plurality of arcs, a short diameter defined by the shortest diameter among diameters passing through a center point of the same circle; and a reflective polarizing film for a polarization beam splitter having a wire grid structure, the reflective polarizing film being configured to be adhered to the curved surface portion so that an angle formed between an arraying direction of wires in the reflective polarizing film and an extending direction of the short diameter of the substrate falls within 45°.

### BACKGROUND

### Field of the Technology

The present disclosure relates to a reflective polarizing optical element, an optical device, a display apparatus, and a method for manufacturing a reflective polarizing optical element.

### Description of the Related Art

In recent years, a head mounted display has been used in various fields including virtual reality (VR), for example, in the fields of augmented reality (AR) and mixed reality (MR). The head mounted display includes an optical system for causing an image displayed on a display to be formed at a position of an eye of a user. In the head mounted display, an optical system that is reduced in size and weight and has a high image quality is achieved by folding an optical path through use of circular polarization and a half mirror. Further, in the head mounted display, for a nose recess for the time of being worn by a user, a shape of each optical element is often not an axisymmetric circular shape unlike a digital camera, but a non-axisymmetric shape that is obtained by cutting off at least one side and has a long axis and a short axis.

In order to impart suitable polarization characteristics to such an optical element, a film having optical characteristics, such as a polarizing film, a polarization beam splitter (PBS) film, or a phase difference film, is laminated onto a substrate having a curved surface. The head mounted display is provided with the optical element obtained in this way, and thus can be reduced in size and weight.

Japanese Patent Laid-Open No. 2015-075746 discloses a reflective polarizing optical element in which a film having a wire grid structure is adhered as a polarization beam splitter film to a curved substrate having a shape like, for example, a spectacle lens. However, it is becoming recognized that, when a wire grid film is adhered to a curved substrate, transmission characteristics for polarized light of the reflective polarizing optical element partially degrade in some cases.

### SUMMARY

The present disclosure has been made in view of such recognition, and is to reduce partial degradation of transmission characteristics for polarized light in a reflective polarizing optical element formed of a curved substrate.

According to one aspect of the present disclosure, there is provided an optical element including a substrate including a curved surface portion having a surface forming a curved surface, the curved surface portion having, in a plan view as viewed in an optical axis direction, when the curved surface portion has a shape surrounded by a plurality of arcs, each of which forms a part of the same circle in the plan view, and by a line connecting ends of adjacent arcs among the plurality of arcs, a short diameter that is defined by the shortest diameter among diameters passing through a center point of the circle in the plan view, the curved surface portion having, when the curved surface portion has a shape formed of an outer shape including a plurality of arcs having different curvatures, a short diameter that is defined by the shortest diameter among diameters passing through a centroid point of the outer shape in the plan view, and a reflective polarizing film for a polarization beam splitter having a wire grid structure, the reflective polarizing film being configured to be adhered to the curved surface portion so that an angle formed between an arraying direction of wires in the reflective polarizing film and an extending direction of the short diameter of the substrate falls within 45°.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic view for illustrating the structure of an example of a reflective polarizing optical element according to a first embodiment.

FIG. 1B is a schematic view for illustrating the structure of the example of the reflective polarizing optical element according to the first embodiment.

FIG. 2A is a schematic view for illustrating another example of a substrate shape of the reflective polarizing optical element according to the first embodiment.

FIG. 2B is a schematic view for illustrating still another example of the substrate shape of the reflective polarizing optical element according to the first embodiment.

FIG. 2C is a schematic view for illustrating still another example of the substrate shape of the reflective polarizing optical element according to the first embodiment.

FIG. 3A is an explanatory view for illustrating stretching of a wire grid film used in the present disclosure.

FIG. 3B is an explanatory view for illustrating stretching of the wire grid film used in the present disclosure.

FIG. 3C is an explanatory view for illustrating stretching of the wire grid film used in the present disclosure.

FIG. 4 is an explanatory view for illustrating a relationship among a short diameter, a long diameter, and half field angles in a curved surface portion.

FIG. 5A is a graph for showing transmittance along the transmission axis of the wire grid film used in the present disclosure.

FIG. 5B is a graph for showing, as a region, a range in which deterioration of transmittance for linearly polarized light along the transmission axis can be particularly suppressed, taking into account the variation in transmittance caused by differences in half field angles.

FIG. 6A is a schematic view for illustrating the structure of an example of a manufacturing apparatus according to the first embodiment.

FIG. 6B is a top view for illustrating a positional relationship between a substrate arranged in the manufacturing apparatus and a wire grid film placed on top of the substrate when seen through from above.

FIG. 7A is a view for illustrating an example of the wire grid film to be adhered and an accompanying configuration.

FIG. 7B is a view for illustrating another example of the wire grid film to be adhered and an accompanying configuration.

FIG. 7C is a view for illustrating still another example of the wire grid film to be adhered and an accompanying configuration.

FIG. 8A is an explanatory view for illustrating an example of a method for manufacturing a reflective polarizing optical element, and is related to one step of the manufacturing method.

FIG. 8B is an explanatory view for illustrating the example of the method for manufacturing a reflective polarizing optical element, and is related to one step of the manufacturing method.

FIG. 8C is an explanatory view for illustrating the example of the method for manufacturing a reflective polarizing optical element, and is related to one step of the manufacturing method.

FIG. 8D is an explanatory view for illustrating the example of the method for manufacturing a reflective polarizing optical element, and is related to one step of the manufacturing method.

FIG. 9A is a schematic view for illustrating a substrate shape used in Example 1.

FIG. 9B is a schematic view for illustrating the substrate shape used in Example 1.

FIG. 10A is a schematic view for illustrating an example of a wire grid film used in Example 1.

FIG. 10B is a schematic view for illustrating another example of the wire grid film used in Example 1.

FIG. 11 is an explanatory view for illustrating the method for manufacturing a reflective polarizing optical element in Example 1.

FIG. 12A is a schematic view for illustrating a substrate shape used in Example 7.

FIG. 12B is a schematic view for illustrating the substrate shape used in Example 7.

FIG. 13 is a schematic view for illustrating a substrate shape used in Example 8.

FIG. 14A is a schematic view for illustrating a substrate shape used in Comparative Example 1.

FIG. 14B is a schematic view for illustrating the substrate shape used in Comparative Example 1.

FIG. 15A is an explanatory view for illustrating another example of the method for manufacturing a reflective polarizing optical element.

FIG. 15B is an explanatory view for illustrating another example of the method for manufacturing a reflective polarizing optical element.

FIG. 16 is a schematic view for illustrating an example of an optical device (display apparatus) according to a second embodiment.

FIG. 17A is a schematic view for illustrating another example of the optical device (display apparatus) according to the second embodiment.

FIG. 17B is a schematic view for illustrating another example of the optical device (display apparatus) according to the second embodiment.

FIG. 17C is a schematic view for illustrating another example of the optical device (display apparatus) according to the second embodiment.

### DESCRIPTION OF THE EMBODIMENTS

Now, exemplary embodiments and Examples are described in detail with reference to the drawings. In the following description, common components throughout the plurality of drawings are denoted by common reference symbols. Accordingly, common components are described with reference to the plurality of drawings mutually, and description of the components denoted by the common reference symbols is omitted as appropriate. Further, dimensions, materials, shapes, relative positions of the components, and the like illustrated in the following embodiments and Examples may be freely selected, and can be changed in accordance with various conditions or a configuration of an apparatus to which the present disclosure is applied.

### First Embodiment

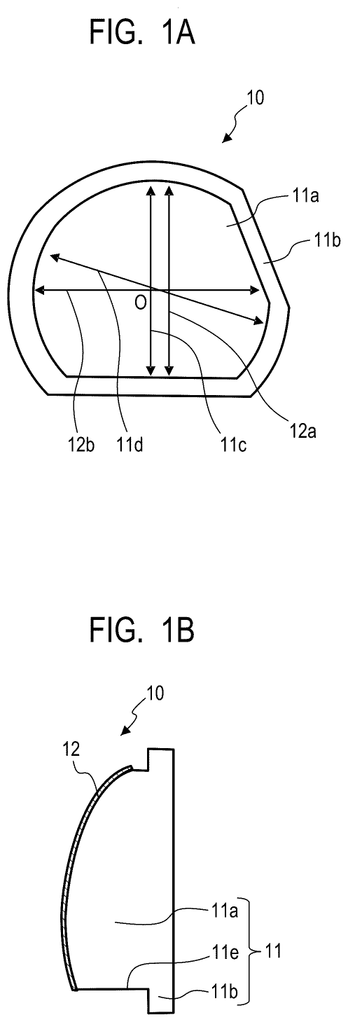

Now, a reflective polarizing optical element and a method for manufacturing a reflective polarizing optical element according to a first embodiment of the present disclosure are described with reference to FIG. 1A to FIG. 8D. FIG. 1A and FIG. 1B are schematic views for illustrating an example of a polarizing optical element according to this embodiment. FIG. 1A is a plan view for illustrating a reflective polarizing optical element 10 as viewed from a light incident direction, and FIG. 1B is a sectional view of the reflective polarizing optical element 10 taken along an arraying direction 12a of wires to be described later.

As illustrated in FIG. 1A and FIG. 1B, the reflective polarizing optical element 10 according to this embodiment includes a substrate 11 and a wire grid film 12. The arraying direction 12a of the wires and an extending direction 12b of the wires in the wire grid film 12 are described later. The exemplified substrate 11 includes a curved surface portion 11a, a peripheral edge portion 11b, and a step portion 11e. In a plan view, the curved surface portion 11a has a shape obtained by connecting, by arcs, two sides that are not opposed to each other across the center, or a shape obtained by removing two regions in a circle outside straight lines that are not opposed to each other. The two unopposed sides or the two unopposed straight lines may be formed by curves. The peripheral edge portion 11b is formed adjacent to an outer circumference of the curved surface portion 11a so as to surround the curved surface portion. The step portion Ile is arranged so as to connect the curved surface portion 11a and the peripheral edge portion 11b together, and is formed here so as to have a surface parallel to the light incident direction.

In the substrate 11 exemplified in FIG. 1A and FIG. 1B, the curved surface portion 11a has a non-axisymmetric shape when viewed in a plan view, and has a short diameter 11c and a long diameter 11d. Here, the long diameter corresponds to a length of an axis with the longest distance passing through a center point O calculated from an arc portion of the curved surface portion 11a in a plan view, and the short diameter corresponds to a length of an axis with the shortest distance passing through the center point O calculated from the arc portion of the curved surface portion 11a in a plan view. Accordingly, the long diameter and the short diameter are not always orthogonal to each other, and depending on the shape of the curved surface portion 11a when viewed in a plan view, a plurality of short diameters and a plurality of long diameters can be selected. Further, the curved surface portion 11a is convex or concave, and may also be aspherical.

The peripheral edge portion 11b is an optically non-effective region and is provided, for example, to serve as a mold release margin when the substrate 11 is manufactured, particularly when the substrate 11 is manufactured by injection molding. Further, the peripheral edge portion 11b may be provided in order to mount the completed reflective polarizing optical element 10 to a casing of an optical device such as a head mounted display. Accordingly, the peripheral edge portion 11b may have, regardless of curved surface or flat surface in particular, an axisymmetric shape or a non-axisymmetric shape. Further, the peripheral edge portion 11b is not required to be provided over the entire circumference of the curved surface portion 11a, and may be provided in a part of the circumference of the curved surface portion 11a. The peripheral edge portion 11b may also be omitted.

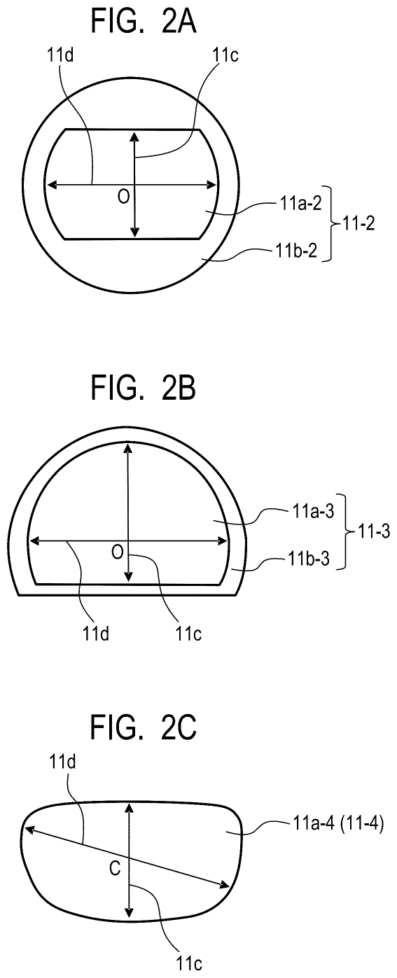

The shape of the substrate when viewed in a plan view, which is assumed in implementing the present disclosure, is not limited to the shape exemplified in FIG. 1A and FIG. 1B. Other examples of the shape of the substrate are described with reference to FIG. 2A to FIG. 2C. FIG. 2A to FIG. 2C are plan views for illustrating other examples of the shape of the substrate in a plan view as viewed in the optical axis direction of the substrate.

In the case of a substrate 11-2 exemplified in FIG. 2A, in a plan view, a curved surface portion 11a-2 has a segmental circle shape including two sides opposed to each other and two arcs connecting the two sides to each other. The two arcs are left in an arrangement to be opposed to each other in a circumference of the same circle, and the two straight lines are provided as two parallel sides that are opposed to each other and connect two pairs of ends that are opposed to each other of those two arcs. In the case of the exemplified substrate 11-2, the substrate 11-2 includes a peripheral edge portion 11b-2 provided in the same width on an outer circumference of the curved surface portion 11a-2 in a plan view.

In the example of the substrate 11-2, the short diameter 11c corresponds to a distance between two straight line parts, which passes through the center point O, and the long diameter 11d is a distance between the two arcs, which passes through the center point O and is in a direction perpendicular to the short diameter 11c. The center point O is defined as a reference point that identifies the short diameter 11c and the long diameter 11d of the substrate 11-2, and is the center point O of the circle forming the two arcs in a plan view.

In the case of a substrate 11-3 exemplified in FIG. 2B, in a plan view, a curved surface portion 11a-3 has a segmental circle shape obtained by removing a portion of the circle outside a straight line. Further, a peripheral edge portion 11b-3 is arranged as a shape similar to the curved surface portion 11a-3 so as to surround an outer circumference of the curved surface portion 11a-3. In the example of the substrate 11-3, the short diameter 11c is a diameter defining the shortest distance, which passes through the center point O in a plan view, and the long diameter 11d is a diameter defining the longest distance, which passes through the center point O and is in the direction perpendicular to the short diameter 11c.

In the example of FIG. 2A or FIG. 2B, a case in which the curved surface portion includes two straight lines in a plan view is described. However, the number of straight lines forming the curved surface portion is not limited to two, and a plurality of three or more straight lines may be included in a plan view of the substrate. In this case, the curved surface portion is only required to include, in a plan view, a plurality of three or more arcs which are parts of the circumference of the same circle, and two adjacent ends of the plurality of straight lines are only required to be connected by each of the arcs.

In the case of a substrate 11-4 exemplified in FIG. 2C, in a plan view, a curved surface portion 11a-4 has a shape formed of a plurality of arcs having different curvatures like, for example, a spectacle lens. As exemplified here, the substrate 11-4 can be formed so as not to include the peripheral edge portion unlike FIG. 1A to FIG. 2B.

Further, in the exemplified substrate 11-4, there is no same circle, and hence the center point cannot be determined in a plan view of the substrate 11-4. In such a case, a center-of-figure point C of the curved surface portion 11a-4 in a plan view of the substrate 11-4 can be used as the reference point. With the center-of-figure point C of the shape of the curved surface portion 11a-4 in a plan view being used as the reference point, the short diameter 11c is a short diameter defined as the shortest diameter among diameters passing through the center-of-figure point C, and the long diameter 11d is a long diameter defined as the longest diameter among the diameters passing through the center-of-figure point C.

An optical device, in particular, a head mounted display in which the reflective polarizing optical element 10 is used is assumed to be worn on a face, in particular, on a part of eyes and a nose of the user, and hence there are restrictions in size of the device. Accordingly, for the purposes of providing a nose recess for the user and securing an installing space for electronic devices such as a motor and a sensor, the shape of the substrate is often not an axisymmetric shape, but a non-axisymmetric shape including a short diameter and a long diameter. In such a case, the substrate shape exemplified in FIG. 2C is assumed. For such a substrate and a curved surface portion, the short diameter and the long diameter can be defined through use of the center-of-figure point C as the reference point as described above.

Any material regardless of plastic or glass can be used as the material for the substrate described above as long as the material is a transparent material that has transparency to light such as visible light being a target of the reflective polarizing optical element 10. When plastic is used, a material that can be formed by injection molding and that is optically used is preferably used. Examples of the material to be used include polycarbonate (PC), polyester (PEs), polymethyl methacrylate (PMMA), a cycloolefin polymer (COP), and a cycloolefin copolymer (COC). In addition, when glass is used, a material thereof is not particularly limited, and examples thereof include synthetic quartz and BK-7 serving as a general glass material.

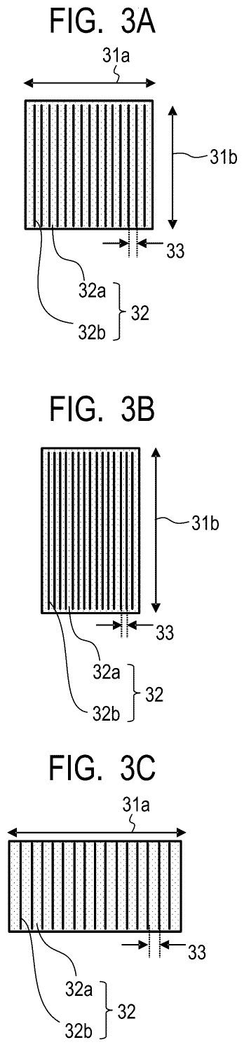

Next, a wire grid film used in the present disclosure is described with reference to FIG. 3A to FIG. 3C. FIG. 3A is a top plan view of a wire grid film, for illustrating the structure of the wire grid film in a simplified manner. A wire grid film 32 includes: a base resin film 32a, which is made of a resin and has a periodic microstructure extending in a certain direction on its surface; and wires 32b, each of which is made of a metal layer deposited on a convex portion of the microstructure and extending in an extending direction of the convex portion.

As optical characteristics, the wire grid film 32 transmits linearly polarized light parallel to an arraying direction 31a of the wires 32b, and reflects linearly polarized light parallel to an extending direction 31b of the wires 32b due to electromagnetic interaction between incident light and the wires forming the periodic microstructure. In order for the wire grid film 32 to exhibit transmittance for visible light, a spacing 33 between the periodically arrayed wires is required to be sufficiently smaller than a wavelength in the visible light range. Accordingly, it has been recognized by the inventor of the present invention that, as the spacing 33 between the wires widens, a transmittance for linearly polarized light to visible light deteriorates.

Here, the wire grid film 32 in a case of being stretched in the extending direction of the wires 32b and the wire grid film 32 in a case of being stretched in the arraying direction are illustrated in FIG. 3B and FIG. 3C, respectively, and effects of the stretching are described. For example, as illustrated in FIG. 3B, even when the wire grid film 32 is stretched along the extending direction 31b of the wire 32b, the spacing between the wires 32b does not widen significantly, and thus a change in transmittance for linearly polarized light is small. In contrast, as illustrated in FIG. 3C, when the wire grid film 32 is stretched along the arraying direction 31a of the wires 32b, the spacing 33 between the wires 32b widens. As a result, the transmittance for linearly polarized light deteriorates markedly.

Examples of a method for adhering the wire grid film to a curved substrate to thereby form a reflective polarizing optical element include vacuum molding, pressure air molding, and insert molding. In order that the flat wire grid film 32 is adhered to a curved substrate by those methods, it is required to stretch the film. In this step, it is assumed that a degree of stretching of the wire grid film 32 becomes larger toward an outer circumferential portion of the curved substrate. At this time, as described above, the stretching of the film causes an increase in the wire spacing in the arraying direction of the wires of the wire grid film 32. Based on the above-mentioned findings, the inventor of the present invention has found that large stretching of the wire grid film 32 occurs at the periphery of the outer circumference of the element and that a marked deterioration of transmittance for linearly polarized light may occur in a region in which the wire grid film is stretched along the arraying direction of the wires 32b.

Referring again to FIG. 1A and FIG. 1B, the reflective polarizing optical element 10 according to the first embodiment of the present disclosure is now described. In the reflective polarizing optical element 10 illustrated in FIG. 1A and FIG. 1B, the arraying direction 12a of the wires in the wire grid film 12 is arranged to be substantially parallel to the extending direction of the short diameter 11c in the substrate 11. Further, the extending direction 12b of the wires is arranged to be orthogonal to the arraying direction 12a. When the wire grid film 12 is adhered to the substrate 11 in such arrangement, it is possible to reduce the region in which the spacing between the wires markedly widens at the time of adhering of the wire grid film 12. Accordingly, it is possible to reduce partial degradation of transmission characteristics for polarized light in the reflective polarizing optical element, in particular, degradation at the outer circumferential portion of the element.

It is preferred that the extending direction of the short diameter 11c and the arraying direction 12a be parallel to each other. However, depending on the shape of the substrate, it is not easy to clearly define the short diameter 11c, and in some cases, the extending direction of the short diameter 11c and a direction in which the wire grid film 12 is most stretched cannot be matched with each other when the wire grid film 12 is adhered to the curved surface portion 11a. Even in such a case, when φ represents an angle formed between the extending direction of the short diameter 11c and the arraying direction 12a, with φ<45° being satisfied, a region in which an amount of stretching of the wire grid film is relatively small can be almost matched with the arraying direction 12a. Further, when the angle is larger than 45°, there is a higher risk in that regions with a large amount of stretching that causes degradation of transmission characteristics for polarized light are included on the curved surface portion 11a. With the setting of such conditions, it is possible to reduce partial degradation of transmission characteristics for polarized light in the reflective polarizing optical element, in particular, degradation at the outer circumferential portion of the element.

As described above, in order to obtain the effect of suppressing deterioration of transmittance for linearly polarized light at the periphery of the outer circumference of the element, it is only required that at least φ≤45° be satisfied. However, in order to more preferably express the effect of the present disclosure, it is further preferred that φ≤30° be satisfied. When the arraying direction 12a of the wires, which is significantly affected by the stretching of the wire grid film, is almost matched with the extending direction of the short diameter 11c, in which the amount of stretching is smallest, the increase in the wire spacing can be suppressed, and hence the deterioration of transmittance for linearly polarized light at the periphery of the outer circumference of the element can be resolved.

With measurement of the transmittance for linearly polarized light at the periphery of the outer circumference of the element, the optical performance of the reflective polarizing optical element 10 described above can be evaluated. For example, with regard to the transmittance for linearly polarized light of light in a desired wavelength range, such as a wavelength range of from 420 nm to 700 nm, when a change in transmittance for linearly polarized light at the periphery of the outer circumference of the element as compared to a designed value is 8% or less, a function as the reflective polarizing optical element is not impaired. Accordingly, when the change in transmittance for linearly polarized light at the periphery of the outer circumference of the element as compared to the designed value is 8% or less, the optical performance of the reflective polarizing optical element can be evaluated as good.

In addition, the optical performance of the reflective polarizing optical element 10 can also be evaluated by directly measuring the wire spacing. For example, when p1 represents the minimum wire spacing of adjacent wires in the curved surface portion 11a of the reflective polarizing optical element 10, and p2 represents the maximum wire spacing, in a case in which p2/p1≤1.18 is satisfied, a change in the wire spacing due to stretching is suppressed, and hence the optical performance can be evaluated as good. Similarly, for example, when q1 represents the wire spacing at the center of the element, and q2 represents the wire spacing at the outer circumferential portion of the element, in a case in which q2/q1≤1.18 is satisfied, the optical performance in the curved surface portion 11a can be evaluated as good.

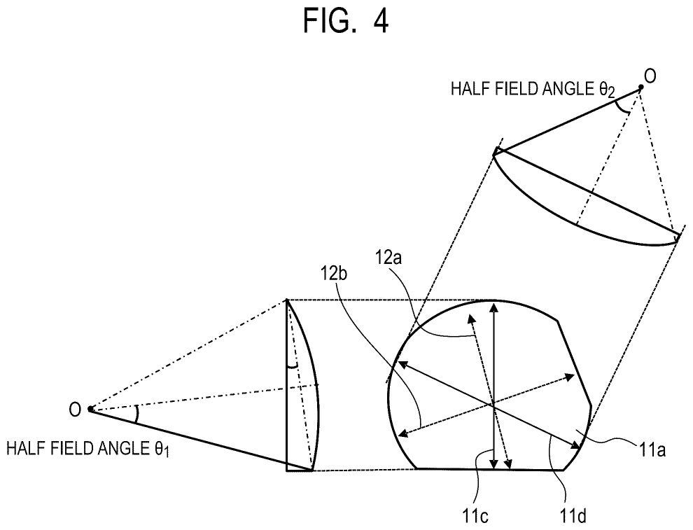

Further, the optical performance of the reflective polarizing optical element 10 can also be controlled by setting half field angles of the substrate 11 appropriately. This is described with reference to FIG. 4. FIG. 4 shows cross-sections taken along the short diameter 11c and the long diameter 11d in the curved surface portion 11a of the substrate 11, respectively, and half field angles θ1 and θ2 obtained from the cross-sections. The half field angles θ1 and θ2 are each obtained by bisecting an angle defined by the center of the sphere and the arc that are obtained from a curvature R of the arc along the short diameter 11c and the long diameter 11d on the curved surface portion 11a (the optimum value by least squares in the case of aspherical surfaces).

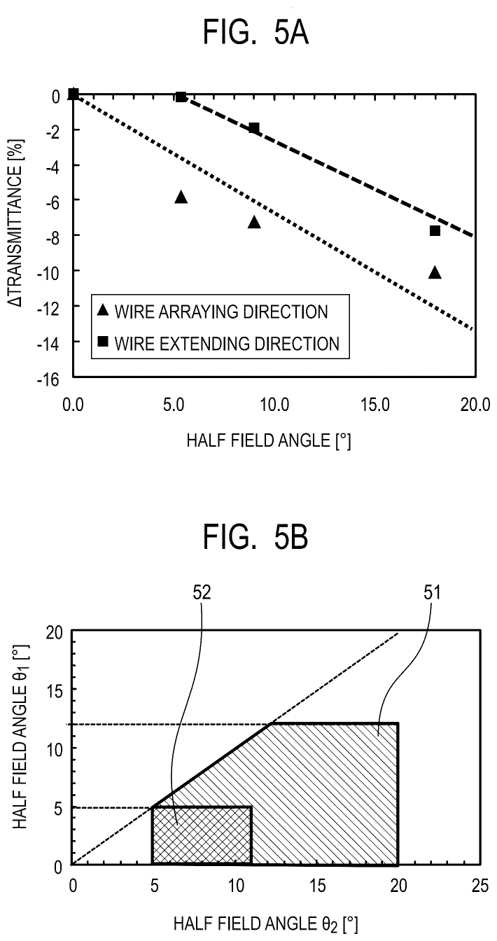

Referring now to FIG. 5A and FIG. 5B, an influence of setting of the half field angles on the optical performance of the reflective polarizing optical element is described. FIG. 5A shows the maximum amount of change in transmittance for linearly polarized light along a wire arraying direction and a wire extending direction when the wire grid film 12 is laminated onto various curved substrates having different half field angles. The maximum amount of change in transmittance (Δ transmittance (%)) is obtained as [(measured value of transmittance)−(transmittance at a reflective polarizing optical element on a flat substrate)]/(transmittance at the reflective polarizing optical element on the flat substrate)×100. According to FIG. 5A, even at the same half field angle, the transmittance deteriorates significantly in the wire arraying direction as compared to the wire extending direction when the wire grid film is laminated onto the substrate because the wire spacing tends to widen in the wire arraying direction.

FIG. 5B shows, as a region, a range in which deterioration of transmittance for linearly polarized light can be particularly suppressed when the wire grid film is adhered so that the short diameter 11c and the arraying direction of the wires are matched with each other while reflecting a difference in transmittance change due to the half field angles. Here, regions in FIG. 5B are expressed by Formulae 1 and 2 below.

θ1<θ2and 0°≤θ1≤12° and 5°<θ2≤20° (Formula 1)

Inθ1<θ2,0°%θ1≤12° and 5°<θ2≤20° (Formula 2)

When Formula 1 is satisfied, the deterioration of transmittance for linearly polarized light at the periphery of the outer circumference of the element is a maximum of 8%, and hence the optical performance of the element can be evaluated as good (region 51). When Formula 2 is satisfied, the deterioration of transmittance for linearly polarized light at the periphery of the outer circumference of the element is a maximum of 3%, and hence the optical performance of the element can be evaluated as extremely good (region 52). In the range of 0°<θ2<5°, the half field angle is small, and hence the shape of the reflective polarizing optical element is not suitable for the optical device targeted in the present disclosure.

Further, as described above, it is not always required that the extending direction of the short diameter 11c and the arraying direction 12a of the wires be matched with each other. When the angle φ formed between those directions satisfies φ<45°, the deterioration of transmittance for linearly polarized light can be suppressed, and with Ω<30° being satisfied, the effect of suppressing the deterioration of transmittance for linearly polarized light is further improved.

Although the angle formed between the extending direction of the short diameter 11c and the arraying direction 12a of the wires satisfies φ<45°, when those directions are not matched with each other) (φ≠0°, a condition similar to Formulae 1 and 2 above can also be set by defining different half field angles. In this case, an extending position of the maximum diameter in a direction along the arraying direction 12a of the wires on the curved surface portion 11a, and an extending position of the maximum diameter along the extending direction 12b of the wires are defined. Then, half field angles θ1′ and θ2′ for the arc drawn on the curved surface portion 11a at both the extending positions are defined similarly to the half field angles θ1 and θ2. In this case, ranges represented by the half field angle θ1′ instead of the half field angle θ1 and by the half field angle θ2′ instead of the half field angle θ2 in Formulae 1 and 2 correspond to the range in which the deterioration of transmittance for linearly polarized light can be particularly suppressed.

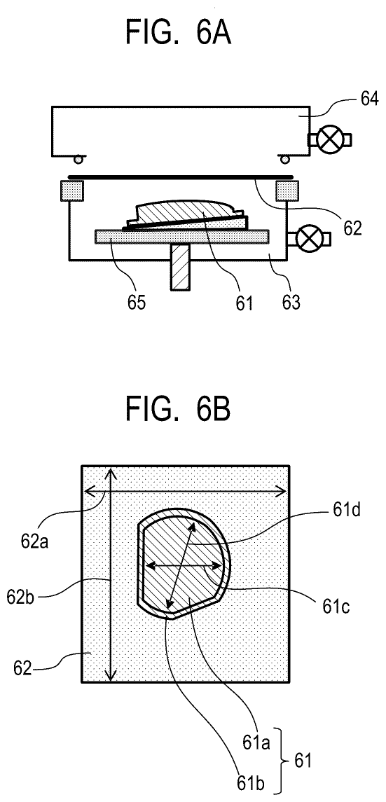

Next, with reference to FIG. 6A and FIG. 6B, a manufacturing apparatus for the reflective polarizing optical element 10 according to this embodiment is described. FIG. 6A is a sectional view for illustrating schematic configurations of the manufacturing apparatus, and a substrate 61 and other components held inside the manufacturing apparatus. Further, FIG. 6B is a top view for illustrating a positional relationship between the substrate arranged in the manufacturing apparatus and the wire grid film placed on top of the substrate when seen through from above.

As illustrated in FIG. 6A, the manufacturing device used in this embodiment includes a first chamber 63, a second chamber 64, and a stage 65. The first chamber 63 and the second chamber 64 can each independently exhaust the inside thereof to reduce the pressure. In an upper portion of the first chamber 63 and a corresponding lower portion of the second chamber 64, opening portions which can be connected to each other are provided. An example in which those chambers are arranged in the vertical direction is given here, but this arrangement is exemplary. The chambers can be arranged laterally or in an arrangement turned upside down.

Inside the first chamber 63, the stage 65 is arranged so as to be capable of moving, for example, ascending and descending, relative to the second chamber 64, while supporting the substrate 61. Similarly to the substrate 11 exemplified in FIG. 1A and FIG. 1B, the substrate 61, which includes a curved surface portion 61a and a peripheral edge portion 61b and whose short diameter 61c and long diameter 61d are defined on the curved surface portion 61a, is placed on the stage 65. Further, a wire grid film 62 is arranged between the first chamber 63 and the second chamber 64, which are connected to each other via the above-mentioned opening portions. At this time, as illustrated in FIG. 6B, in a plan view, the substrate 61 including the curved surface portion 61a and the peripheral edge portion 61b is arranged to face the wire grid film 62 so that an arraying direction 62a of the wires and an extending direction of the short diameter 61c of the substrate 61 are matched with each other. Further, in accordance with the foregoing, in a plan view, an extending direction 62b of the wires is arranged so that an angle formed between an extending direction of the long diameter 61d of the substrate 61 and the extending direction 62b of the wires is 30° or less.

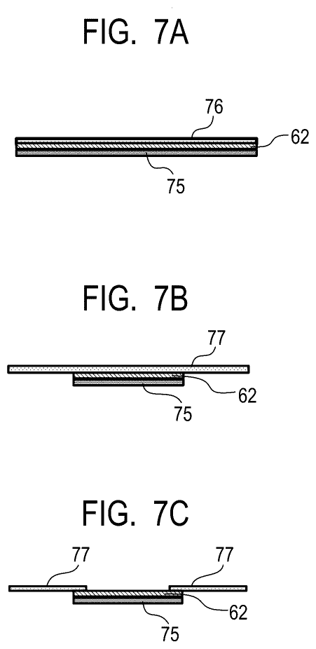

In the manufacture of the reflective polarizing optical element 10, the wire grid film 62 can be accompanied with other configurations. Those configurations are described with reference to FIG. 7A to FIG. 7C. FIG. 7A to FIG. 7C each schematically show a cross-section of the wire grid film and the like to be used in an adhering step.

As exemplified in FIG. 7A, a uniform adhesive layer 75 can be provided on a surface of the wire grid film 62 on the substrate side. Further, a protective film 76 that is used for protecting a surface of the wire grid film 62 can also be provided on a surface (surface opposite to the adhesive layer 75) of the wire grid film 62 on a side opposite to the substrate side. It is required that a glass transition temperature of the protective film 76 be lower than a glass transition temperature of the wire grid film 62. This increases the strength of the wire grid film 62, and hence the wire grid film 62 is less liable to tear or break when the wire grid film 62 is adhered to the substrate 61.

Further, the wire grid film 62 is expensive as compared to a general film. Accordingly, from the viewpoint of reducing the manufacturing cost, it is inappropriate to use a wire grid film 62 having a size excessively larger than the area of the curved surface portion 61a of the substrate 61. That is, the wire grid film 62 is only required to have a size slightly larger than a surface area of the curved surface portion 61a of the substrate 61. Specifically, for example, the wire grid film 62 is only required to have an area that is from 1.5 times to 2.5 times the area of the curved surface portion 61a in a plan view as viewed in the optical axis direction of the substrate 61.

Here, when the size of the wire grid film 62 is reduced as much as possible, at the time of holding the wire grid film 62 between the first chamber 63 and the second chamber 64, it is required to, for example, secure also the size required for this holding. Accordingly, as illustrated in FIG. 7B, on the wire grid film 62, a support film 77 formed of a member separate from the wire grid film 62 may be adhered. At this time, in order to obtain a uniform film warpage at the time of heating the film, it is preferred that the glass transition temperature of the support film 77 be a temperature equivalent to or lower by about 20° C. than the glass transition temperature of the wire grid film 62.

Further, as illustrated in FIG. 7C, a support film 77 may be adhered only to the outer peripheral portion of the wire grid film 62. The support film 77 can be separated from the wire grid film 62 at an appropriate timing after the wire grid film 62 is adhered to the substrate 61.

In a step of adhering the wire grid film 62, the wire grid film 62 and the like described above are held between the first chamber 63 and the second chamber 64. In the manufacturing apparatus described in this embodiment, the stage 65 is provided to tilt the substrate 61 so that a tangent line at the center point of the short diameter 61c of the substrate 61 is parallel to the wire grid film 62. With this configuration, in the substrate 61, a situation of stretching of the wire grid film 62 along the extending direction of the short diameter 61c is symmetrical about the center point of the short diameter 61c. This prevents the wire grid film 62 from having a region with partially large stretching due to the adhering, and the wire grid film 62 can be adhered with the maximum stretching rate of the wire grid film 62 being reduced.

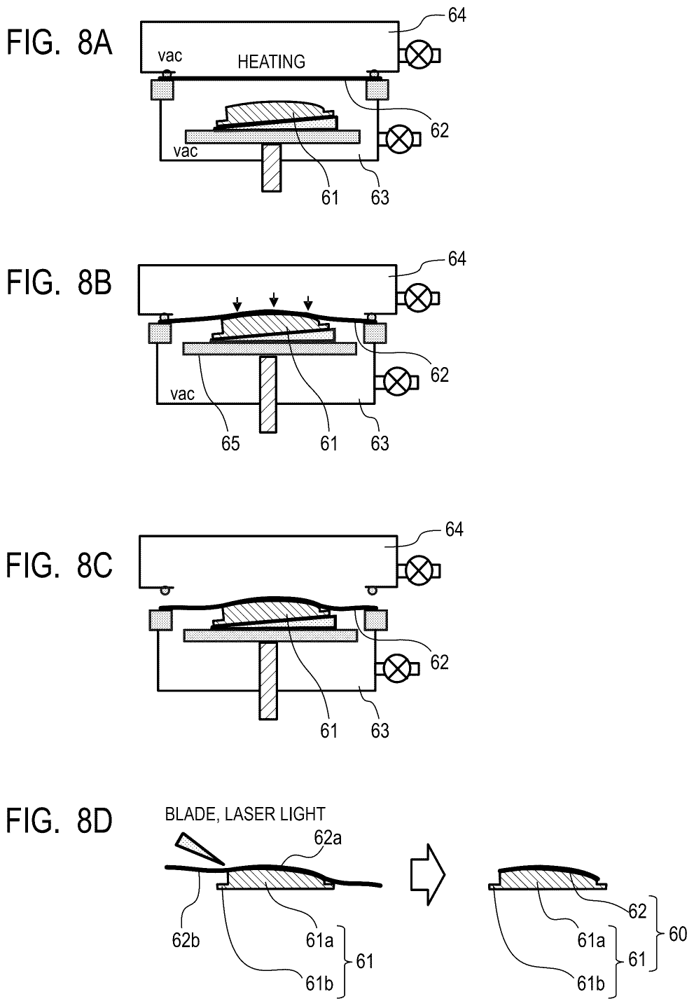

Next, the step of adhering the wire grid film 62 to the substrate 61 through use of the manufacturing apparatus described with reference to FIG. 6A is described with reference to FIG. 8A to FIG. 8D. After the substrate 61 and the wire grid film 62 are arranged in the manufacturing apparatus as illustrated in FIG. 6A, a vacuum is created in the first chamber 63 and the second chamber 64 as illustrated in FIG. 8A. Then, the wire grid film 62 is heated through use of, for example, a heater installed in the second chamber 64. After heating the wire grid film 62 to a desired temperature, as illustrated in FIG. 8B, the stage 65 is raised to bring the curved surface portion 61a of the substrate 61 into contact with the wire grid film 62. The stage 65 is further raised so that the wire grid film 62 is adhered to a front surface of the curved surface portion 61a.

Then, as illustrated in FIG. 8C, the wire grid film 62 is pressurized and pressed onto the substrate 61 by opening only the second chamber 64 to the atmosphere to increase the pressure, and as required, by adding high-pressure gas. At this time, as required, heating and pressurizing of the wire grid film 62 may be continued for a certain period of time.

Here, as measures for heating the wire grid film 62, an infrared heater that directly heats the film is generally used, but there is also a method in which the entire first chamber 63 and second chamber 64 are heated by a heater or the like. In this case, the substrate 61 is also heated. In particular, when the substrate 61 is made of a plastic material, there is a fear of deformation due to heat. Accordingly, it is important that the stage 65 that supports the substrate 61 or a pedestal that directly supports the substrate 61 has the heat insulating structure. In other words, it is preferred that, regardless of the temperature of the wire grid film 62, the temperature of the substrate 61 be 120° C. or less.

After that, the heating and pressurizing of the wire grid film 62 is stopped, the second chamber 64 is restored to atmospheric pressure, and then the first chamber 63 is also opened to the atmosphere. Subsequently, the substrate 61 to which the wire grid film 62 has been adhered is taken out. Next, as illustrated in FIG. 8D, an unrequired wire grid film 62d is cut off so that a wire grid film 62c remains only on the curved surface portion 61a of the substrate 61. Examples of measures for cutting off the unrequired wire grid film 62d include a method of cutting off the unrequired wire grid film 62d by putting a blade along the outer edge of the curved surface portion 61a or by applying laser light along the outer edge of the curved surface portion 61a. In this way, a reflective polarizing optical element 60 is manufactured with the wire grid film 62 adhered to the curved surface portion 61a of the substrate 61.

Now, Examples in each of which the reflective polarizing optical element according to this embodiment was actually manufactured are described below. In the evaluation of the optical performance of the reflective polarizing optical element as described below, the transmittance for linearly polarized light is measured and the evaluation is based on the results. In the evaluation of the optical performance, when the change in transmittance for linearly polarized light at the periphery of the outer circumference of the element as compared to the designed value is 3% or less, the evaluation result is A because there is no significant influence on the optical performance and it is considered extremely good. When the change in transmittance for linearly polarized light at the periphery of the outer circumference of the element as compared to the designed value is 8% or less, the evaluation result is B because there is no significant problem with optical performance. When the change in transmittance for linearly polarized light at the periphery of the outer circumference of the element as compared to the designed value is more than 8%, the evaluation result is C because the degradation of optical performance along the extending direction of the short diameter of the element is not negligible and it is considered defective.

### Example 1

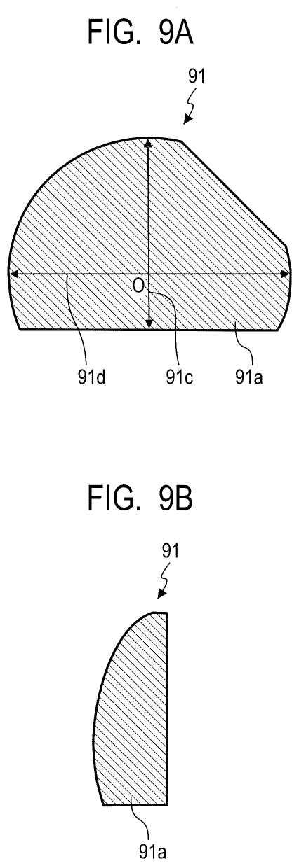

In Example 1, as a substrate 91, a substrate that had a shape exemplified in FIG. 9A and FIG. 9B and had been molded by injection molding was used. Further, as a material for the substrate 91, plastic containing cyclic olefin copolymer (COC) as a main component was used. In detail, as illustrated in FIG. 9A, the shape of the substrate 91 in a plan view has a curved surface portion 91a with two unopposed sides connected by arcs. The curved surface portion 91a of the substrate 91 forms a convex lens in which a length L1 of a short diameter 91c is 26.7 mm, a length L2 of a long diameter 91d is 40.0 mm, a half field angle θ1 is 15°, a half field angle θ2 is 22°, and no peripheral edge portion is provided.

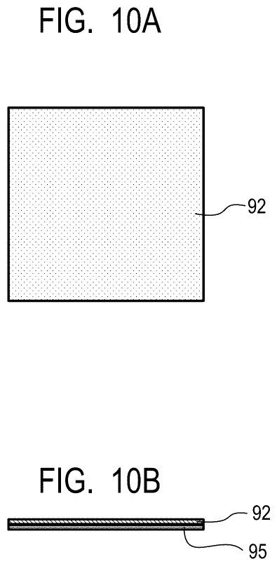

As a wire grid film 92 and the like to be adhered to the substrate 91, an article having a shape illustrated in a plan view in FIG. 10A and a sectional view in FIG. 10B was used. Specifically, the article included the wire grid film 92 with a thickness of about 0.1 mm and an adhesive layer 95, and had a size of 80 mm×80 mm.

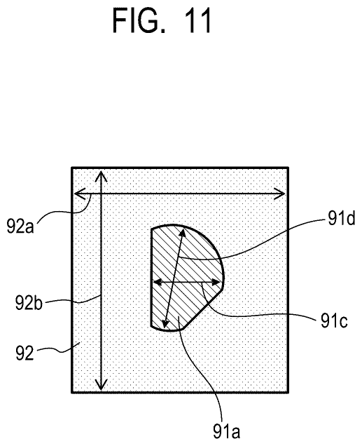

The substrate 91, the wire grid film 92, and the like were set to have a positional relationship illustrated in FIG. 11 in a plan view, and were arranged in the manufacturing apparatus exemplified in FIG. 6A. Further, when the substrate 91 was arranged in the first chamber 63, the substrate 91 was arranged in a tilted manner so that a tangent line at the center point of the short diameter 91c was parallel to the wire grid film 92. Further, the substrate 91 was arranged so that an extending direction of the short diameter 91c of the curved surface portion 91a of the substrate 91 and an arraying direction 92a of the wires of the wire grid film 92 were substantially parallel to each other (within)±2°. Further, in the step exemplified in FIG. 8A, the wire grid film 92 and the like were heated to a desired temperature (140° C.) through use of an infrared heater.

After heating the wire grid film 92 and the like, the curved surface portion 91a of the substrate 91, and the wire grid film 92 and the like (adhesive layer 95) were brought into contact with each other in the step exemplified in FIG. 8B. Then, in the step exemplified in FIG. 8C, only the second chamber 64 was opened to the atmosphere, and compressed air was caused to flow into the second chamber 64 to increase the pressure to 0.3 MPa. Thus, the wire grid film 92 and the like were pressurized and pressed onto the substrate 91 for 10 seconds. Then, the heating and pressurizing of the wire grid film 92 and the like was stopped, the second chamber 64 was restored to atmospheric pressure, and the first chamber 63 was also opened to the atmosphere.

Finally, in the step exemplified in FIG. 8D, the unrequired wire grid film was cut off by putting a blade along the outer edge of the curved surface portion 91a, to thereby leave only the wire grid film 92 on the curved surface portion 91a of the substrate 91. In this way, a reflective polarizing optical element was manufactured with the wire grid film 92 adhered to the curved surface portion 91a of the substrate 91.

The optical performance of this reflective polarizing optical element was evaluated based on the method and criteria described above. As a result, as shown in Table 1, it could be confirmed that the reflective polarizing optical element according to this example exhibited good optical performance.

### Example 2

In Example 2, the shape (dimensions and the like) of the substrate 91 used in Example 1 was changed. Specifically, a reflective polarizing optical element was manufactured in the same way as in Example 1, except that for the substrate 91, the length L1 of the short diameter 91c of the curved surface portion 91a was set to 35.7 mm, the length L2 of the long diameter 91d was set to 60.0 mm, the half field angle θ1 was set to 12°, and the half field angle θ2 was set to 20°. Then, the optical performance of this reflective polarizing optical element was evaluated based on the method and criteria described above. As a result, as shown in Table 1, similarly to Example 1, it could be confirmed that the reflective polarizing optical element according to this example exhibited good optical performance.

### Example 3

In Example 3, the shape of the substrate 91 used in Example 1 was changed. Specifically, a reflective polarizing optical element was manufactured in the same way as in Example 1 while the dimensions and the like of the substrate 91 were set to be the same as those of the substrate 91 in Example 1, except that for the substrate 91, the curved surface portion 91a was formed into a concave lens. Then, the optical performance of this reflective polarizing optical element was evaluated based on the method and criteria described above. As a result, as shown in Table 1, similarly to Example 1, it could be confirmed that the reflective polarizing optical element according to this example exhibited good optical performance.

### Example 4

In Example 4, the shape (dimensions and the like) of the substrate 91 used in Example 1 was changed. Specifically, a reflective polarizing optical element was manufactured in the same way as in Example 1, except that for the substrate 91, the length L1 of the short diameter 91c of the curved surface portion 91a was set to 32.9 mm, the length L2 of the long diameter 91d was set to 40.0 mm, the half field angle θ1 was set to 12°, and the half field angle θ2 was set to 20°. Then, the optical performance of this reflective polarizing optical element was evaluated based on the method and criteria described above. As a result, as shown in Table 1, similarly to Example 1, it could be confirmed that the reflective polarizing optical element according to this example exhibited good optical performance.

### Example 5

In Example 5, the shape (dimensions and the like) of the substrate 91 used in Example 1 was changed. Specifically, a reflective polarizing optical element was manufactured in the same way as in Example 1, except that for the substrate 91, the length L1 of the short diameter 91c of the curved surface portion 91a was set to 39.9 mm, the length L2 of the long diameter 91d was set to 60.0 mm, the half field angle θ1 was set to 4°, and the half field angle θ2 was set to 6°. Then, the optical performance of this reflective polarizing optical element was evaluated based on the method and criteria described above. As shown in Table 1, when the transmittance for linearly polarized light at the periphery of the outer circumference of the element was measured, the change in transmittance for linearly polarized light as compared to the designed value fell within 3%. Thus, it could be confirmed that the reflective polarizing optical element according to this example exhibited good optical performance.

### Example 6

In Example 6, the shape (dimensions and the like) of the substrate 91 used in Example 1 was changed. Specifically, a reflective polarizing optical element was manufactured in the same way as in Example 1, except that for the substrate 91, the length L1 of the short diameter 91c of the curved surface portion 91a was set to 25.0 mm, the length L2 of the long diameter 91d was set to 40.0 mm, the half field angle θ1 was set to 5°, and the half field angle θ2 was set to 8°. Then, the optical performance of this reflective polarizing optical element was evaluated based on the method and criteria described above. As shown in Table 1, when the transmittance for linearly polarized light at the periphery of the outer circumference of the element was measured, the change in transmittance for linearly polarized light as compared to the designed value fell within 3%. Thus, it could be confirmed that the reflective polarizing optical element according to this example exhibited good optical performance.

### Example 7

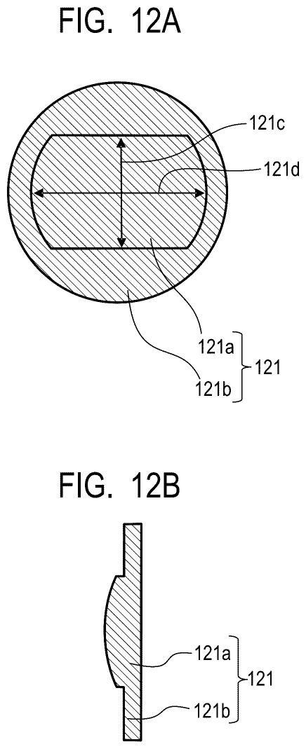

In Example 7, the shape of the substrate 91 used in Example 1 was changed. Specifically, as illustrated in a plan view in FIG. 12A and a sectional view in FIG. 12B, a substrate was formed to include a curved surface portion 121a having a segmental circle shape obtained by removing portions of the circle outside two opposed sides when viewed in a plan view, and to include a peripheral edge portion 121b surrounding the curved surface portion 121a adjacently to the curved surface portion 121a. In this case, the length L1 of a short diameter 121c of the curved surface portion 121a was 36.5 mm, the length L2 of a long diameter 121d was 60.0 mm, the half field angle θ1 was 12°, the half field angle θ2 was 20°, and the flat peripheral edge portion 121b of 62 mm was provided. A reflective polarizing optical element was manufactured in the same way as in Example 1. The optical performance of this reflective polarizing optical element was evaluated based on the method and criteria described above. As a result, as shown in Table 1, similarly to Example 1, it could be confirmed that the reflective polarizing optical element according to this example exhibited good optical performance.

### Example 8

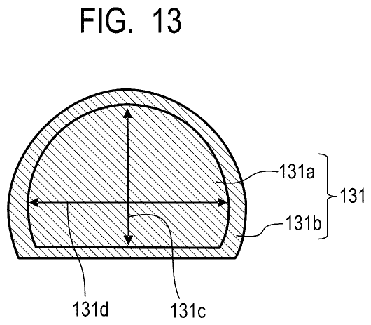

In Example 8, the shape of the substrate 91 used in Example 1 was changed. Specifically, as illustrated in a plan view in FIG. 13, a substrate 131 was formed to include a curved surface portion 131a having a segmental circle shape obtained by removing a portion of the circle outside one straight line when viewed in a plan view, and to include a peripheral edge portion 131b adjacent to the curved surface portion 131a in a shape similar to the curved surface portion 131a. In this case, the length L1 of a short diameter 131c of the curved surface portion 131a was 26.8 mm, a length of a long diameter 131d was 40.0 mm, the half field angle θ1 was 10°, the half field angle θ2 was 15°, and the flat peripheral edge portion 131b was 2 mm wide. A reflective polarizing optical element was manufactured in the same way as in Example 1. The optical performance of this reflective polarizing optical element was evaluated based on the method and criteria described above. As shown in Table 1, when the transmittance for linearly polarized light at the periphery of the outer circumference of the element was measured, the change in transmittance for linearly polarized light as compared to the designed value fell within 8%. Thus, it could be confirmed that the reflective polarizing optical element according to this example exhibited good optical performance.

### Example 9

In Example 9, the shape (dimensions and the like) of the substrate 91 used in Example 1 was changed. Specifically, for the substrate 91, the length L1 of the short diameter 91c of the curved surface portion 91a was set to 40.2 mm, the length L2 of the long diameter 91d was set to 50 mm, the half field angle θ1 was set to 12°, and the half field angle θ2 was set to 15°. This substrate 91 was arranged in the manufacturing apparatus exemplified in FIG. 6A and the like, and the corresponding wire grid film 92 and the like were arranged as exemplified in FIG. 8A. Further, as the wire grid film 92 and the like, the wire grid film 92 accompanied with, for example, the adhesive layer 75 was used. The substrate 91 and the wire grid film 92 were arranged so that the angle formed between the arraying direction of the wires in the wire grid film 92 and the extending direction of the short diameter 91c of the curved surface portion 91a of the substrate 91 was 30°. A reflective polarizing optical element was manufactured in the same way as in Example 1. The optical performance of this reflective polarizing optical element was evaluated based on the method and criteria described above. As a result, as shown in Table 1, similarly to Example 1, it could be confirmed that the reflective polarizing optical element according to this example exhibited good optical performance.

### Comparative Example 1

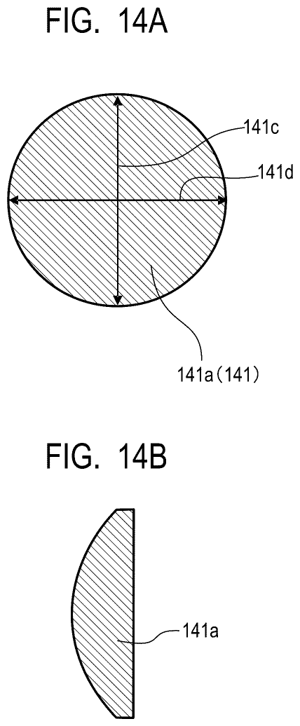

In Comparative Example 1, the shape of the substrate 91 used in Example 1 was changed. Specifically, as illustrated in a plan view in FIG. 14A and a sectional view in FIG. 14B, a curved surface portion 141a of a substrate 141 was formed into a circular shape in a plan view so as to have a short diameter 141c and a long diameter 141d of the same length L1 of 40.0 mm. Further, the half field angles θ1 and θ2 were set to 22°. A reflective polarizing optical element was manufactured in the same way as in Example 1. The optical performance of this reflective polarizing optical element was evaluated based on the method and criteria described above. As shown in Table 1, when the transmittance for linearly polarized light at the periphery of the outer circumference of the element was measured, the change in transmittance for linearly polarized light as compared to the designed value was 8% or more, which was evaluated as poor optical performance because the transmittance for linearly polarized light deteriorated and hence the optical performance was judged to be problematic.

### Comparative Example 2

In Comparative Example 2, without changing the shape of the substrate 91 used in Example 1, the length L1 of the short diameter 91c of the curved surface portion 91a of the substrate 91 was set to 26.7 mm, the length L2 of the long diameter 91d was set to 40.0 mm, the half field angle θ1 was set to 15°, and the half field angle θ2 was set to 22°. This substrate 91 was arranged in the manufacturing apparatus exemplified in FIG. 6A and the like. In this case, in this comparative example, as the wire grid film 92 and the like, the wire grid film 92 accompanied with, for example, the adhesive layer 75 was used. The substrate 91, the wire grid film 92, and the like were arranged so that the angle formed between the extending direction of the short diameter 91c of the curved surface portion 91a of the substrate 91 and the arraying direction 92a of the wires of the wire grid film 92 was 50°. A reflective polarizing optical element was manufactured in the same way as in Example 1. The optical performance of this reflective polarizing optical element was evaluated based on the method and criteria described above. As shown in Table 1, when the transmittance for linearly polarized light at the periphery of the outer circumference of the element was measured, the change in transmittance for linearly polarized light as compared to the designed value was 8% or more, which was evaluated as poor optical performance because the transmittance for linearly polarized light deteriorated and hence the optical performance was judged to be problematic.

TABLE 1

| | | | | | | | Angle | |
|---|---|---|---|---|---|---|---|---|
| | | | | | | | formed | |
| | | | | | | | between | |
| | | | | | | | extending | |
| | | | | | | | direction | |
| | | | | | | | of short | |
| | | | | | | | diameter | |
| | | | | | | | and | |
| | | | | Short | Long | | arraying | |
| | Shape of | Half field | Half field | diameter | diameter | Curvature | direction | |
| | curved | angle | angle | L1 | L2 | radius | of wires | Result (Δ |
| | surface | θ1 [°] | θ2 [°] | [mm] | [mm] | R [mm] | [°] | transmittance) |
| Example 1 | Convex | 15 | 22 | 26.7 | 40 | 53 | 0 | B |
| Example 2 | Convex | 12 | 20 | 35.7 | 60 | 88 | 0 | B |
| Example 3 | Concave | 15 | 22 | 26.7 | 40 | 53 | 0 | B |
| Example 4 | Convex | 10 | 12 | 32.9 | 40 | 96 | 0 | B |
| Example 5 | Convex | 4 | 6 | 39.9 | 60 | 287 | 0 | A |
| Example 6 | Convex | 5 | 8 | 25 | 40 | 144 | 0 | A |
| Example 7 | Convex | 12 | 20 | 36.5 | 60 | 88 | 0 | B |
| Example 8 | Convex | 10 | 15 | 26.8 | 40 | 77 | 0 | B |
| Example 9 | Convex | 12 | 15 | 40.2 | 50 | 97 | 30 | B |
| Comparative | Convex | 22 | 22 | 40 | 40 | 53 | 0 | C |
| Example 1 | | | | | | | | |
| Comparative | Convex | 15 | 22 | 26.7 | 40 | 53 | 50 | C |
| Example 2 | | | | | | | | |

The evaluation results of Examples and Comparative Examples described above support the findings by the inventor of the present invention that, toward the outer circumference of the curved substrate, the wire grid film is stretched and the transmission characteristics for polarized light of the reflective polarizing optical element degrade. The implementation of the present disclosure can reduce the partial degradation of the transmission characteristics for polarized light of the reflective polarizing optical element formed of a curved substrate, and in particular, can avoid to some extent the degradation at the periphery of the outer circumference in a direction perpendicular to the wires.

In Comparative Example 1 described above, the substrate 141 including a curved surface portion having a circular shape in a plan view is used. In this case, the region in which the transmittance for linearly polarized light deteriorates exists at an end portion of the wire grid film 92 adhered to the substrate 141, in an extending direction of the arraying direction 92a of the wires. Accordingly, for example, after the wire grid film is adhered, at least one part of the substrate and the wire grid film within an angular range of ±22.5° with respect to the arraying direction 92a of the wires is removed, thereby being capable of obtaining a reflective polarizing optical element having suitable transmittance for linearly polarized light as a whole.

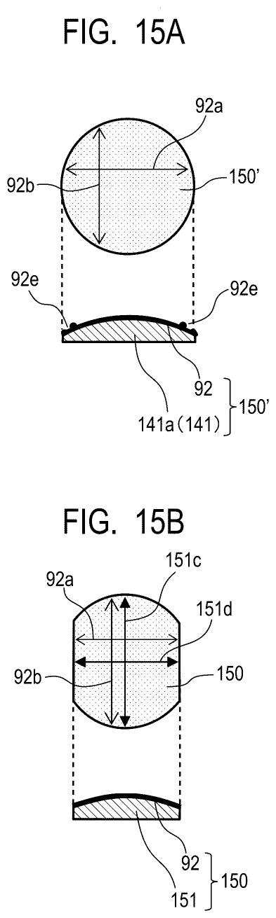

A method for manufacturing such a reflective polarizing optical element is described below as other embodiments of the present disclosure. FIG. 15A and FIG. 15B are views for schematically illustrating a final step in the manufacturing method. FIG. 15A shows a plan view and a sectional view for illustrating an example of a reflective polarizing optical element after portions of a wire grid film that exist outside a curved surface portion are cut off. Further, FIG. 15B shows a plan view and a sectional view for illustrating an example of the reflective polarizing optical element after portions with degraded polarization optical characteristics are further removed. A step of adhering the wire grid film to the substrate is the same as the step described with reference to FIG. 8A to FIG. 8D, and hence description thereof is omitted here.

FIG. 15A shows a reflective polarizing optical element 150′ in which the wire grid film 92 is simply adhered to the curved surface portion 141a of the substrate 141 having a circular shape in a plan view. In this case, the wire grid film 92 has the arraying direction 92a and an extending direction 92b of the wires, and as exemplified in FIG. 15A, there is a characteristic degrading region 92e on each end portion of the curved surface portion 141a in the arraying direction 92a, in the wire grid film 92. When the arraying direction 92a is defined as a direction passing through the center of the circular shape defining the curved surface portion 141a, this region corresponds to a region outside a chord defining a range of +22.5° around the arraying direction 92a of the circular shape. Accordingly, with this region outside the chord being removed, the remaining reflective polarizing optical element 150 can be treated as having suitable polarization optical characteristics.

FIG. 15B schematically shows the reflective polarizing optical element 150 from which two regions outside the range of ±22.5° with respect to the arraying direction 92a of the wires are removed. As illustrated in FIG. 15B, in a plan view, the arraying direction 92a of the wires is substantially matched with an extending direction of a short diameter 151c of a substrate 151 of the reflective polarizing optical element 150 after the removing step. Further, the extending direction 92b of the wires is substantially matched with a long diameter 151d of the substrate 151 in a plan view. With obtaining of the step as described above, a reflective polarizing optical element according to one aspect of the present disclosure can also be obtained.

### Second Embodiment

The reflective polarizing optical element according to the first embodiment described above can be applied to various devices and apparatus such as an optical device, a display apparatus, and an imaging apparatus. Specifically, the reflective polarizing optical element can be used in optical devices such as a head mounted display, a digital camera, and a video camera. In this embodiment, an optical device and a display apparatus are described as specific application examples of the reflective polarizing optical element according to the first embodiment.

### (Optical Device)

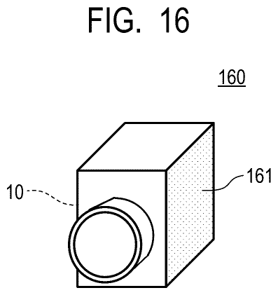

Specific application examples of the reflective polarizing optical element according to the first embodiment include a lens for forming an optical device (photographing optical system) for a camera or a video camera, and a lens for forming an optical device (projecting optical system) for a liquid crystal projector. FIG. 16 is a schematic view for illustrating an example of an exemplary embodiment of an optical device 160 using the reflective polarizing optical element according to the first embodiment. An optical system included in the optical device 160 includes a plurality of lenses arranged in a casing 161, and the reflective polarizing optical element 10 according to the first embodiment can be used for at least one of those lenses.

### (Display Apparatus)

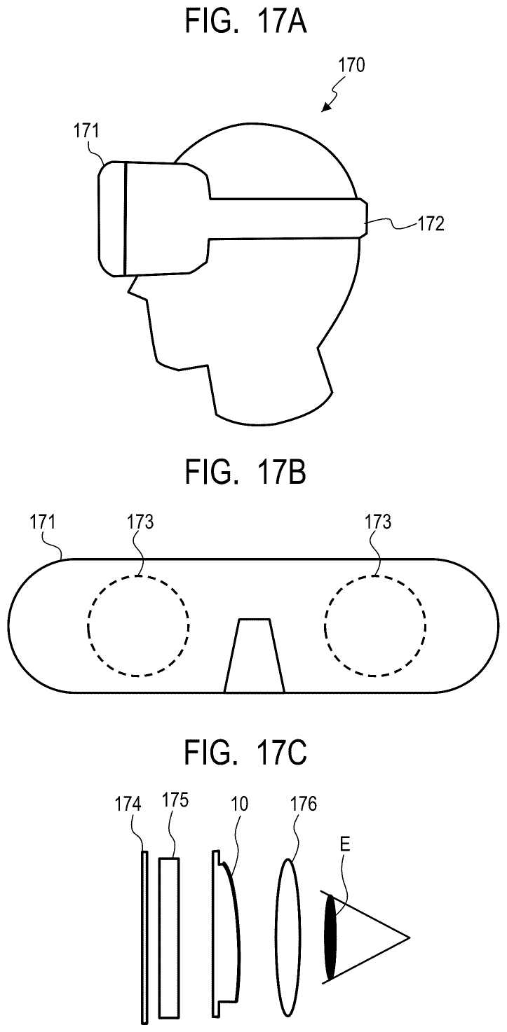

FIG. 17A to FIG. 17C are schematic views for illustrating a configuration of a head mounted display (HMD) 170 which is an example of an exemplary embodiment of a display apparatus using the reflective polarizing optical element 10 according to the first embodiment. FIG. 17A is a side view for illustrating the HMD 170. FIG. 17B is a front view for illustrating the HMD 170. FIG. 17C is a schematic view for illustrating an optical system of the HMD 170.

As illustrated in FIG. 17A and FIG. 17B, the HMD 170 includes a casing 171, a mounting member 172, and display units 173 for a left eye and a right eye, which are arranged in the casing 171. The HMD 170 is mounted on a head of the user by the mounting member 172 so that the display units 173 for the left eye and the right eye are positioned so as to correspond to the left eye and the right eye of the user, respectively.

As illustrated in FIG. 17C, each of the display units 173 includes a display panel 174 and optical elements 10, 175, and 176. For example, the reflective polarizing optical element 10 according to the first embodiment can be used for the optical system. The display panel 174 is a display portion formed of an organic electroluminescence (EL) panel, a liquid crystal panel, or the like, and displays a corresponding video for the left eye or the right eye. The optical elements 10, 175, and 176 image video light emitted from the display panel 174 to the position of an eye E of the user. The optical elements 10, 175, and 176 may include optical-path changing elements depending on the design of the HMD 170. Examples of the optical-path changing elements include transmissive optical elements such as a convex lens and a concave lens, reflective optical elements such as a concave mirror, and phase difference optical elements such as a mirror and a half mirror. The reflective polarizing optical element 10 is installed so as to be positioned between the optical element 175 and the optical element 176 and the eye E. The reflective polarizing optical element 10 forms an optical system together with the optical elements 175 and 176 so as to guide video light that is light emitted from the display panel 174, to the eye of the user, and functions as at least one of optical elements, that is, lenses in the optical system.

Here, a mode using the HMD has been described as the display apparatus to which the reflective polarizing optical element is applied, but the mode of the display apparatus according to this embodiment is not limited to this example. For example, also for a display apparatus in a mode of a projector or the like, the reflective polarizing optical element 10 according to this embodiment can be used similarly to the above-mentioned example.

As described above, a reflective polarizing optical element according to one aspect of the present disclosure includes a substrate and a reflective polarizing film with a wire grid structure, which is exemplified by the wire grid film 12 and the like. For example, the substrate 11 includes the curved surface portion 11a having a surface forming a curved surface. For example, as in the substrate 11-2 or 11-3 exemplified in FIG. 2A or FIG. 2B, in a plan view as viewed in an optical axis direction, the curved surface portion can have a shape surrounded by a plurality of arcs, each of which forms a part of the same circle, and a line connecting ends of adjacent arcs among the plurality of arcs. In such a case, in the present disclosure, the shortest diameter among diameters passing through the center point of this circle in a plan view is defined as a short diameter. Further, for example, as in the substrate 11-4 exemplified in FIG. 2C, in a plan view as viewed in the optical axis direction, the curved surface portion can have a shape formed of an outer shape including a plurality of arcs having different curvatures. In such a case, in the present disclosure, the shortest diameter among diameters passing through a centroid point of this outer shape in a plan view is defined as a short diameter. The reflective polarizing film is adhered to the curved surface portion so that an angle formed between an arraying direction of wires in the wire grid and an extending direction of the short diameter of the substrate falls within 45°. When the extending direction of the short diameter of the substrate and the arraying direction of the wires are arranged to have such a positional relationship, it is possible to reduce a region in which a spacing between the wires is widened, thereby being capable of reducing the partial degradation of transmission characteristics for polarized light in the reflective polarizing optical element.

In order to obtain the effect of the present disclosure, it is more preferred that the angle formed between the arraying direction of the wires and the extending direction of the short diameter of the substrate further fall within 30°. When the arraying direction of the wires and the extending direction of the short diameter are approximated to parallel arrangement, the partial degradation of the transmission characteristics for polarized light can be more effectively reduced. In order to obtain the effect of the present disclosure, it is preferred that a half field angle, which is defined by the short diameter and a long diameter defined with respect to the short diameter, fall within a predetermined range. In this case, the half field angle at a position at which the short diameter of the curved surface portion 11a is defined is represented by θ1. At this time, the longest diameter among diameters passing through the center point of the circle forming a part of the outer shape of the curved surface portion in a plan view, or the longest diameter among diameters passing through the centroid point of the outer shape is defined as a long diameter. Further, the half field angle at a position of the curved surface portion at which the long diameter is defined in a plan view is represented by θ2. At this time, when, in θ1<θ2, 0°<θ1≤12° and 5°<θ2≤20° are satisfied, the transmission characteristics for polarized light of the reflective polarizing optical element can be maintained more effectively. With regard to the half field angles of the substrate, it is more preferred to satisfy 0°<θ1≤5° and 5°≤θ2≤11°.

Further, in the present disclosure, better conditions are also determined from the spacing between the wires of the wire grid film from the viewpoint of maintaining the transmission characteristics for polarized light. That is, with regard to a spacing between adjacent wires in the reflective polarizing film in a state of being adhered to the substrate, when p1 represents the minimum wire spacing and p2 represents the maximum wire spacing, it is more preferred to satisfy p2/p1≤1.18. Further, when, under the adhered state, ql represents a spacing between adjacent wires in a center region of the curved surface portion and q2 represents a spacing between wires in a region close to the outer circumference of the shape of the curved surface portion, it is more preferred to satisfy q2/q1≤1.18.

Further, in the present disclosure, for example, as exemplified in FIG. 1A and FIG. 1B, the substrate 11 can include the peripheral edge portion 11b provided at a peripheral edge of the curved surface portion 11a. Such a peripheral edge portion 11b is formed, thereby obtaining the effect, such as improvement in degree of freedom when the reflective polarizing optical element is fixed to the optical device. Further, as exemplified in FIG. 7A to FIG. 7C, the reflective polarizing film can be adhered to the curved surface portion through intermediation of the adhesive layer 75. This can reduce restrictions in material, which may arise with respect to heating of the reflective polarizing film.

Further, the present disclosure can form an optical device (160, 170) including a casing (161, 171) and an optical system that is arranged in the casing and includes at least one optical element including, for example, the reflective polarizing optical element 10 described above. In addition, the present disclosure can form a display apparatus including a casing 171, an optical system (10, 175, 176) that is arranged in the casing and includes at least one optical element, and a display portion (174) that emits light to be guided by the optical system.

Further, the method for manufacturing a reflective polarizing optical element according to one aspect of the present disclosure includes a step of adhering a reflective polarizing film for a polarization beam splitter having a wire grid structure to a substrate including a curved surface portion having a surface forming a curved surface. In this case, when the curved surface portion has the shape exemplified in FIG. 2A or FIG. 2B in a plan view as viewed in the optical axis direction, the shortest diameter among diameters passing through the center point of the single circle forming a plurality of arcs in a plan view can be defined as a short diameter. Further, when the curved surface portion has the shape exemplified in FIG. 2C, the shortest diameter among diameters passing through the centroid point of the outer shape including a plurality of arcs having different curvatures in a plan view can be defined as a short diameter. The reflective polarizing film is adhered to the curved surface portion so that an angle formed between an arraying direction of the wires and an extending direction of the short diameter of the substrate falls within 45°. In addition, when the curved surface portion is convex, for example, the extending direction of the short diameter can also be defined as an extending direction of a straight line in a plan view, which connects a point on the curved surface with which the reflective polarizing film is first brought into contact at the time of adhering, and a point on the circumference of the curved surface that the reflective polarizing film first reaches to each other. Further, when the curved surface portion is concave, the extending direction of the short diameter can also be defined as a direction that is the shortest distance connecting between a point on the circumference of the curved surface with which the reflective polarizing film is first brought into contact at the time of adhering, and a point on the curved surface, such as the centroid point of the curved surface portion, at which adhering is to be finished.

When the reflective polarizing film is adhered to the curved surface portion, as described with reference to FIG. 8A, the substrate 61 can be arranged so that the tangent line at the center point of the short diameter 61c of the curved surface portion 61a is parallel to the reflective polarizing film (62). Specifically, the substrate 61 is tilted and supported by adding an inclined pedestal having a triangular sectional shape between the substrate 61 and the stage 65. This allows a distance between the point at which the reflective polarizing film is first brought into contact with the curved surface portion at the time of adhering, and the point at which the reflective polarizing film is lastly brought into contact with the curved surface portion to be set to ½ of the short diameter, thereby being capable of stretching the film in the short diameter direction to a desired length.

When the reflective polarizing film is adhered to the curved surface portion, the angle formed between the arraying direction of the wires and the extending direction of the short diameter of the substrate is set to fall within 30°, thereby being capable of obtaining the effect of the present disclosure more suitably.

Further, the reflective polarizing optical element according to one aspect of the present disclosure can also be obtained by other methods. For example, a reflective polarizing film for a polarization beam splitter having a wire grid structure may be adhered to a curved surface portion of a substrate having a surface forming a curved surface, and then a portion with inferior transmission characteristics for polarized light may be removed. In this case, the portion with inferior transmission characteristics for polarized light is included in the angular range within ±22.5° with respect to the arraying direction of the wires of the reflective polarizing film. Accordingly, with at least one end portion of the curved surface portion corresponding to this portion being removed, the reflective polarizing optical element according to one aspect of the present disclosure can also be obtained. In this case, when the removal of at least one end portion of the substrate is performed on an end portion of the curved surface portion at an angle within ±15° with respect to the arraying direction of the wires of the reflective polarizing film, a more suitable reflective polarizing optical element is obtained.

Adhering the reflective polarizing film to the curved surface portion can be performed by pressing the reflective polarizing film onto the substrate. Further, the reflective polarizing film in a heated state can also be adhered to the curved surface portion.

According to one aspect of the present disclosure, it is possible to reduce partial degradation of transmission characteristics for polarized light in a reflective polarizing optical element formed of a curved substrate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-134895, filed Aug. 13, 2024, which is hereby incorporated by reference herein in its entirety.

What is claimed is:

1. A reflective polarizing optical element comprising:
a substrate including a curved surface portion having a surface forming a curved surface, the curved surface portion having, in a plan view as viewed in an optical axis direction, when the curved surface portion has a shape surrounded by a plurality of arcs, each of which forms a part of the same circle in the plan view, and by a line connecting ends of adjacent arcs among the plurality of arcs, a short diameter that is defined by the shortest diameter among diameters passing through a center point of the circle in the plan view, the curved surface portion having, when the curved surface portion has a shape formed of an outer shape including a plurality of arcs having different curvatures, a short diameter that is defined by the shortest diameter among diameters passing through a centroid point of the outer shape in the plan view; and
a reflective polarizing film for a polarization beam splitter having a wire grid structure, the reflective polarizing film being configured to be adhered to the curved surface portion so that an angle formed between an arraying direction of wires in the reflective polarizing film and an extending direction of the short diameter of the substrate falls within 45°.

2. The reflective polarizing optical element according to claim 1, wherein the angle formed between the arraying direction of the wires and the extending direction of the short diameter of the substrate falls within 30°.

3. The reflective polarizing optical element according to claim 1, wherein in a condition of θ1<θ2, 0°<θ1≤12° and 5°<θ2≤20° are satisfied,
where θ1 represents a half field angle at a position at which the short diameter of the curved surface portion is defined, and θ2 represents a half field angle at a position of the curved surface portion at which a long diameter of the curved surface portion is defined in the plan view as the longest diameter among diameters passing through the center point of the circle or the longest diameter among diameters passing through the centroid point of the outer shape.

4. The reflective polarizing optical element according to claim 3, wherein with regard to the half field angles of the substrate, 0°<θ1≤5° and 5°<θ2≤11° are satisfied.

5. The reflective polarizing optical element according to claim 1, wherein with regard to a spacing between adjacent wires in the reflective polarizing film in an adhered state, p2/p1≤1.18 is satisfied,
where p1 represents the minimum wire spacing, and p2 represents the maximum wire spacing.

6. The reflective polarizing optical element according to claim 1, wherein q2/q1≤1.18 is satisfied,
where q1 represents a spacing between adjacent wires in a center region of the curved surface portion in the reflective polarizing film in an adhered state, and q2 represents a spacing between wires in a region close to an outer circumference of the shape of the curved surface portion.

7. The reflective polarizing optical element according to claim 1, wherein the substrate includes a peripheral edge portion provided at a peripheral edge of the curved surface portion.

8. The reflective polarizing optical element according to claim 1, wherein the reflective polarizing film is adhered to the curved surface portion through intermediation of an adhesive layer.

9. An optical device comprising:
a casing; and
an optical system including at least one optical element arranged in the casing,
wherein the at least one optical element includes the reflective polarizing optical element of claim 1.

10. A display apparatus comprising:
a casing;
an optical system including at least one optical element arranged in the casing; and
a display portion configured to emit light to be guided by the optical system,
wherein the at least one optical element includes the reflective polarizing optical element of claim 1.

11. A method for manufacturing a reflective polarizing optical element comprising:
defining, in a substrate including a curved surface portion having a surface forming a curved surface, in a plan view as viewed in an optical axis direction, when the curved surface portion has a shape surrounded by a plurality of arcs, each of which forms a part of the same circle in the plan view, and by a line connecting ends of adjacent arcs among the plurality of arcs, a short diameter of the curved surface portion that is defined by the shortest diameter among diameters passing through a center point of the circle in the plan view, or defining, when the curved surface portion has a shape formed of an outer shape including a plurality of arcs having different curvatures, a short diameter of the curved surface portion that is defined by the shortest diameter among diameters passing through a centroid point of the outer shape in the plan view; and
adhering a reflective polarizing film for a polarization beam splitter having a wire grid structure to the curved surface portion so that an angle formed between an arraying direction of wires in the reflective polarizing film and an extending direction of the short diameter of the substrate falls within 45°.

12. The method for manufacturing a reflective polarizing optical element according to claim 11, wherein, when the reflective polarizing film is adhered to the curved surface portion, the substrate is arranged so that a tangent line at a center point of the short diameter of the curved surface portion is parallel to the reflective polarizing film.

13. The method for manufacturing a reflective polarizing optical element according to claim 11, wherein, when the reflective polarizing film is adhered to the curved surface portion, the angle formed between the arraying direction of the wires and the extending direction of the short diameter of the substrate falls within 30°.

14. A method for manufacturing a reflective polarizing optical element comprising:
adhering a reflective polarizing film for a polarization beam splitter having a wire grid structure to a curved surface portion of a substrate, the curved surface portion having a surface forming a curved surface; and
removing at least one end portion of the curved surface portion at an angle within ±22.5° with respect to an arraying direction of wires of the reflective polarizing film after the adhering.

15. The method for manufacturing a reflective polarizing optical element according to claim 14, wherein the removing at least one end portion of the substrate is performed on an end portion of the curved surface portion at an angle within ±15° with respect to the arraying direction of the wires of the reflective polarizing film.

16. A method for manufacturing a reflective polarizing optical element comprising adhering a reflective polarizing film for a polarization beam splitter having a wire grid structure to a substrate including a curved surface portion having a surface forming a curved surface,
wherein in a plan view when the substrate is viewed in an optical axis direction, an angle formed between an extending direction of a straight line that connects a point on the curved surface with which the reflective polarizing film is first brought into contact at the time of the adhering, and a point on a circumference of the curved surface that the reflective polarizing film first reaches to each other, and an arraying direction of wires in the wire grid structure falls within 45°.
